(19) United States
(12) Patent Application Publication
(10) Pub. No.: US 2010/0054096 A1
(43) Pub. Date: Mar. 4, 2010

(54) REPRODUCTION APPARATUS, CONTROL PROGRAM, RECORDING MEDIUM, AND CONTROL METHOD FOR CONTROLLING REPRODUCTION OF CONTENT

(76) Inventor: Jiro Kiyama, Osaka (JP)

Correspondence Address: BIRCH STEWART KOLASCH & BIRCH, PO BOX 747, FALLS CHURCH, VA, 22040-0747, US

(21) Appl. No.: 12/517,157

(22) PCT Filed: Oct. 16, 2007
(86) PCT No.: PCT/JP2007/070110

§ 371 Date: Jun. 1, 2009

(30) Foreign Application Priority Data
Dec. 5, 2006 (JP) 2006-328156

(51) Int. Cl. G11B 20/00

(52) U.S. Cl. 369/47.15; G9B/20

(57) ABSTRACT

A program execution unit for executing a reproduction control program for controlling reproduction of a content, a reproduction control unit for controlling reproduction of the obtained content based on a control instruction from the program execution unit based on a content reproduction control instruction from a user, and a notification unit for giving notification based on a result of determination as to whether content reproduction control by the reproduction control unit is control corresponding to the reproduction control instruction or not are included.

### TECHNICAL FIELD

The present invention relates to a reproduction apparatus, a control program, a recording medium, and a control method for controlling reproduction of a content by executing a program.

### BACKGROUND ART

Contents and reproduction apparatuses complying with next-generation video disc specifications such as Blu-ray Disc (trademark) (BD) and HD DVD (trademark) (High-Definition Digital Versatile Disc) have been marketed.

Video images complying with the next-generation video disc specifications above are of higher resolution than video images complying with conventional DVD (Digital Versatile Disc) specifications. In addition, audio complying with the next-generation video disc specifications is of higher quality than audio complying with conventional DVD specifications. In addition, the next-generation video disc specifications are adapted to schemes for creating more extensive and interactive contents attracting users than the conventional DVD specifications. Examples of such schemes include an environment for execution of a Java (trademark) language representing a general-purpose programming language complying with the BD (Blu-ray Disc) specifications representing the next-generation video disc specifications.

A reproduction apparatus complying with the BD specifications representing the next-generation video disc specifications (hereinafter also referred to as a BD player) provides an environment for execution of a Java (trademark) program and also various APIs (Application Program Interface). The provided APIs can implement control of a behavior of the BD player such as content reproduction control and graphics drawing control by an executed Java (trademark) program. Therefore, the BD player can reproduce contents incomparably more sophisticated and elaborate than a DVD player.

FIG. 14 is a functional block diagram of an internal configuration of a conventional reproduction apparatus 10000. Reproduction apparatus 10000 has a function to execute a general-purpose program (such as a Java (trademark) program). Reproduction apparatus 10000 is assumed as a reproduction apparatus complying with the BD specifications. For the sake of illustration, FIG. 14 also shows a recording medium 10, a remote controller 200, and a display apparatus 300. Recording medium 10 is, for example, a Blu-ray Disc (trademark). Recording medium 10 stores a program PGM, AV (Audio Visual) data AVDT representing a content, various types of data, and the like. Program PGM includes a reproduction control program for controlling reproduction of a content. Recording medium 10 is inserted in a not-shown insertion portion provided in reproduction apparatus 10000.

Display apparatus 300 having a function to display a character, an image, or the like is connected to reproduction apparatus 10000.

Referring to FIG. 14, reproduction apparatus 10000 includes a control unit 105, a recording medium access unit 110, and an RC signal reception unit 120.

Control unit 105 carries out various types of control over each unit in the apparatus.

Recording medium access unit 110 reads AV data AVDT, program PGM, a playlist PLYLST, auxiliary information PGINF, PYINF which will be described later, or the like from recording medium 10. AV data AVDT is content data including video images and audio.

RC signal reception unit 120 has a function to receive a remote control signal (hereinafter also referred to as an RC signal) transmitted from remote controller 200.

FIG. 15 is a diagram showing exemplary appearance of remote controller 200. Referring to FIG. 15, remote controller 200 includes an RC signal transmission unit 205, a power button 210, a medium ejection button 212, a numeric button group 220, and a button group 230.

RC signal transmission unit 205 has a function to transmit an RC signal. For example, an RC signal transmitted by RC signal transmission unit 205 is an infrared signal.

Power button 210 is a button for transmitting a power RC signal from RC signal transmission unit 205 when pressed by a user. The power RC signal is a signal for switching on and off the power of a destination apparatus.

Medium ejection button 212 is a button for transmitting a medium ejection RC signal from RC signal transmission unit 205 when pressed by the user. The medium ejection RC signal is an RC signal for ejecting recording medium 10 inserted in the insertion portion of the reproduction apparatus to the outside.

Numeric button group 220 includes a plurality of numeric buttons. Each of the plurality of numeric buttons is a button for transmitting a corresponding RC signal from RC signal transmission unit 205 when pressed by the user.

Button group 230 includes a volume button and a channel selection button. The volume button is a button for transmitting a volume RC signal from RC signal transmission unit 205 when pressed by the user. The volume RC signal is a signal for changing the volume of audio output from a destination apparatus. The channel selection button is a button for transmitting a channel selection RC signal from RC signal transmission unit 205 when pressed by the user. The channel selection RC signal is a signal for changing a channel set in a destination apparatus.

Remote controller 200 further includes a reproduction manipulation button group 240. Reproduction manipulation button group 240 includes a play button 241, a stop button 242, a pause button 243, a fast play button 246, and a slow play button 247.

Play button 241 is a button for transmitting a play RC signal from RC signal transmission unit 205 when pressed by the user. The play RC signal is a signal for playing a content in a destination apparatus. Stop button 242 is a button for transmitting a stop RC signal from RC signal transmission unit 205 when pressed by the user. The stop RC signal is a signal for stopping a content being played in a destination apparatus.

Pause button 243 is a button for transmitting a pause RC signal from RC signal transmission unit 205 when pressed by the user. The pause RC signal is a signal for causing a content being played in a destination apparatus to pause. Fast play button 246 is a button for transmitting a fast play RC signal from RC signal transmission unit 205 when pressed by the user. The fast play RC signal is a signal for multiplying a play speed of a content being played in a destination apparatus, for example, by n (natural number) (such as 2). Slow play button 247 is a button for transmitting a slow play RC signal from RC signal transmission unit 205 when pressed by the user. The slow play RC signal is a signal for multiplying a play speed of a content being played in a destination apparatus, for example, by 1/n (natural number) (such as ½).

Play button 241, stop button 242, pause button 243, fast play button 246, and slow play button 247 are denoted as “play”, “stop”, “pause”, “fast play”, and “slow play”, respectively.

Referring again to FIG. 14, RC signal reception unit 120 receives an RC signal transmitted from remote controller 200 and converts the RC signal to button information BTINF corresponding to the received RC signal. Button information BTINF is information for identifying a button corresponding to the received RC signal. Button information BTINF is, for example, a button name. Here, for example, if a received RC signal is the pause RC signal, button information BTINF indicates of the button name “pause”.

Reproduction apparatus 10000 further includes a program execution unit 130, a reproduction control unit 140, an AV decoding unit 150, an OSD (On Screen Display) generation unit 180, and a combination unit 190.

Recording medium access unit 110 transmits program PGM and auxiliary information PGINF read from recording medium 10 to program execution unit 130. Auxiliary information PGINF is information relating to program PGM.

Program execution unit 130 performs graphics drawing processing by executing program PGM transmitted from recording medium access unit 110.

In the graphics drawing processing, program execution unit 130 generates an image PGIMG. Image PGIMG is uncompressed bit map data. It is noted that image PGIMG is not limited to bit map data and it may be compressed data (such as JPEG data). Program execution unit 130 transmits generated image PGIMG to combination unit 190.

RC signal reception unit 120 transmits button information BTINF to control unit 105 and program execution unit 130.

In addition, program execution unit 130 further performs button information analysis processing by executing program PGM. In the button information analysis processing, program execution unit 130 analyzes button information BTINF transmitted from RC signal reception unit 120.

Moreover, program execution unit 130 further performs content reproduction control processing by executing a reproduction control program included in program PGM. As described previously, the reproduction control program is a program for controlling reproduction of a content.

Program execution unit 130 transmits reproduction control information PLYINF to reproduction control unit 140. Reproduction control information PLYINF is information for controlling reproduction of AV data AVDT representing a content.

In addition, recording medium access unit 110 reads playlist PLYLST and auxiliary information PYINF from recording medium 10 based on a read instruction from control unit 105 and transmits read playlist PLYLST and auxiliary information PYINF to reproduction control unit 140. Auxiliary information PYINF is information relating to playlist PLYLST.

Reproduction control unit 140 controls AV decoding unit 150 based on reproduction control information PLYINF from program execution unit 130 and playlist PLYLST and auxiliary information PYINF from recording medium access unit 110.

In addition, reproduction control unit 140 transmits play state information PLYST to OSD generation unit 180. Play state information PLYST is information indicating a content play state in reproduction control unit 140. Namely, play state information PLYST is information indicating a play state of AV data AVDT representing a content. Play state information PLYST is information indicating any of a “play state”, a “stop state”, a “pause state”, and a “special play state.” The “play state” indicates that AV data AVDT representing a content is being played. The “stop state” indicates that reproduction of AV data AVDT (content data) has been stopped. The “pause state” indicates that reproduction of AV data AVDT (content data) has paused.

The “special play state” indicates that a play state of AV data AVDT (content data) is either a fast play state or a slow play state. The fast play state refers to a play state set when fast play RC signal described previously is received from remote controller 200. The slow play state refers to a play state set when slow play RC signal described previously is received from remote controller 200.

Recording medium access unit 110 transmits AV data AVDT (content data) read from recording medium 10 to AV decoding unit 150. It is noted that AV data AVDT (content data) is data compressed in an MPEG (Moving Picture Experts Group) 2 format. Alternatively, AV data AVDT may be data compressed in other formats, without limited to data compressed in the MPEG2 format. Here, other formats include, for example, MPEG1, MPEG4, H.264, and the like.

AV decoding unit 150 decodes AV data AVDT (content data) from recording medium access unit 110 under the control of reproduction control unit 140, and successively converts AV data AVDT to a decoded image DCIMG as a frame. Decoded image DCIMG is an uncompressed image. Then, AV decoding unit 150 successively transmits decoded image DCIMG to combination unit 190 each time it provides decoded image DCIMG as a frame.

OSD generation unit 180 generates a play state display image PLYIMG based on play state information PLYST from reproduction control unit 140. For example, when play state information PLYST indicates “play”, play state display image PLYIMG is an image showing a message that the content is being played. Namely, play state display image PLYIMG is an image for notifying the user of the content play state. Play state display image PLYIMG is uncompressed bit map data. It is noted that play state display image PLYIMG may be compressed data (such as JPEG data), without limited to bit map data. OSD generation unit 180 transmits generated play state display image PLYIMG to combination unit 190.

Combination unit 190 generates a composite image CMPIMG obtained by combining decoded image DCIMG transmitted from AV decoding unit 150, image PGIMG transmitted from program execution unit 130, and play state display image PLYIMG transmitted from OSD generation unit 180 in a manner superimposed on one another. Then, combination unit 190 transmits composite image CMPIMG to display apparatus 300 connected to reproduction apparatus 10000.

Japanese Patent Laying-Open No. 2005-025913 (Patent Document 1) discloses a technique to display an image in accordance with a play state of a content in a manner superimposed on a content being played, as in reproduction apparatus 10000 described previously.

Patent Document 1: Japanese Patent Laying-Open No. 2005-025913 (FIGS. 7 and 8)

### DISCLOSURE OF THE INVENTION

### Problems to be Solved by the Invention

As described previously, the reproduction apparatus complying with the next-generation video disc specifications (such as the BD specifications) is capable of sophisticated content display, as the APIs capable of executing a general-purpose program language including a program for controlling reproduction of a content and the APIs capable of controlling various behaviors of the reproduction apparatus are provided. In addition, as the sophisticated APIs as above are provided, the reproduction apparatus complying with the next-generation video disc specifications is also capable, for example, of performing processing other than reproduction of a content when the play button of the remote controller is pressed, or for example, not permitting a specific manipulation during play of a content, depending on generation of a program for controlling reproduction of a content included in the general-purpose program language.

Namely, the reproduction apparatus complying with the next-generation video disc specifications is capable of sophisticated content reproduction control by executing a program for controlling reproduction of a content included in the general-purpose program language.

In the reproduction apparatus complying with the next-generation video disc specifications, however, in a case where assignment of a function to be executed is inappropriate or in a case where a manipulation not permitted is inappropriate when a certain button of the remote controller is pressed, the user may be confused. For example, when processing other than content stop processing is assigned to the stop button of the remote controller or when a content stop manipulation with the stop button of the remote controller is not permitted, the user cannot stop reproduction of the content and the user may make a complaint.

An information reproduction apparatus disclosed in Japanese Patent Laying-Open No. 2005-025913 (Patent Document 1) is not an apparatus capable of controlling various behaviors of the reproduction apparatus by executing a general-purpose program language including a program for controlling reproduction of a content. Therefore, the technique disclosed in Japanese Patent Laying-Open No. 2005-025913 (Patent Document 1) cannot solve the above-described problems in the reproduction apparatus complying with the next-generation video disc specifications.

The present invention was made to solve the above-described problems, and an object of the present invention is to provide a reproduction apparatus, a control program, a recording medium, and a control method capable of executing a program for controlling reproduction of a content and eliminating confusion from the user when reproduction control expected by the user is not carried out.

### Means for Solving the Problems

In order to solve the problems described above, according to one aspect of the present invention, a reproduction apparatus capable of executing a reproduction control program for controlling reproduction of a content includes: an obtaining unit for obtaining the content and the reproduction control program; a program execution unit for executing the reproduction control program; an acceptance unit for accepting an instruction to control reproduction of the content from a user; a reproduction control unit for controlling reproduction of the content obtained by the obtaining unit, based on a control instruction from the program execution unit based on the instruction to control reproduction accepted by the acceptance unit; a determination unit for determining whether control of reproduction of the content carried out by the reproduction control unit is control corresponding to the instruction to control reproduction accepted by the acceptance unit; and a notification unit for providing notification based on a result of determination by the determination unit.

Preferably, the notification unit provides notification when the determination unit determines that control of reproduction of the content carried out by the reproduction control unit is not control corresponding to the accepted instruction to control reproduction.

Preferably, the control instruction issued by the program execution unit to the reproduction control unit based on the instruction to control reproduction is an instruction for control permitted in the reproduction control program.

According to another aspect of the present invention, a control program executed by a computer capable of executing a reproduction control program for controlling reproduction of a content includes: an obtaining step of obtaining the content and the reproduction control program; a program execution step of executing the reproduction control program; an acceptance step of accepting an instruction to control reproduction of the content from a user, the program execution step including a step of outputting a control instruction based on the instruction to control reproduction accepted in the acceptance step; a reproduction control step of controlling reproduction of the content obtained in the obtaining step based on the control instruction; a determination step of determining whether control of reproduction of the content carried out in the reproduction control step is control corresponding to the instruction to control reproduction accepted in the acceptance step; and a notification step of providing notification based on a result of determination in the determination step.

Preferably, in the notification step, notification is provided when it is determined in the determination step that control of reproduction of the content carried out in the reproduction control step is not control corresponding to the accepted instruction to control reproduction.

According to yet another aspect of the present invention, a computer-readable recording medium is a medium recording the control program.

According to yet another aspect of the present invention, a control method performed in a reproduction apparatus capable of executing a reproduction control program for controlling reproduction of a content includes: an obtaining step of obtaining the content and the reproduction control program; a program execution step of executing the reproduction control program; an acceptance step of accepting an instruction to control reproduction of the content from a user, the program execution step including a step of outputting a control instruction based on the instruction to control reproduction accepted in the acceptance step; a reproduction control step of controlling reproduction of the content obtained in the obtaining step based on the control instruction; a determination step of determining whether control of reproduction of the content carried out in the reproduction control step is control corresponding to the instruction to control reproduction accepted in the acceptance step; and a notification step of providing notification based on a result of determination in the determination step.

Preferably, in the notification step, notification is provided when it is determined in the determination step that control of reproduction of the content carried out in the reproduction control step is not control corresponding to the accepted instruction to control reproduction.

### EFFECTS OF THE INVENTION

The reproduction apparatus according to the present invention includes the program execution unit for executing the reproduction control program for controlling reproduction of a content, the reproduction control unit for controlling reproduction of the obtained content based on the control instruction from the program execution unit based on the instruction to control reproduction from the user, and the notification unit for providing notification based on the result of determination as to whether control of reproduction of the content carried out by the reproduction control unit is control corresponding to the instruction to control reproduction or not.

Namely, notification is provided based on the result of determination as to whether control of reproduction of the content carried out by the reproduction control unit is control corresponding to the instruction to control reproduction of the content from the user or not. Therefore, an effect to eliminate confusion from the user when reproduction control expected by the user is not carried out can be achieved.

The control program according to the present invention includes: the program execution step of executing the reproduction control program for controlling reproduction of a content, the program execution step outputting a control instruction based on the instruction to control reproduction of the content from the user; the reproduction control step of controlling reproduction of the obtained content based on the control instruction; and the notification step of providing notification based on a result of determination as to whether control of reproduction of the content carried out in the reproduction control step is control corresponding to the instruction to control reproduction or not.

Namely, notification is provided based on the result of determination as to whether control of reproduction of the content carried out in the reproduction control step is control corresponding to the instruction to control reproduction of the content from the user or not. Therefore, an effect to eliminate confusion from the user when reproduction control expected by the user is not carried out can be achieved.

The recording medium according to the present invention records a control program. The control program includes: the program execution step of executing the reproduction control program for controlling reproduction of a content, the program execution step outputting a control instruction based on the instruction to control reproduction of the content from the user; the reproduction control step of controlling reproduction of the obtained content based on the control instruction; and the notification step of providing notification based on a result of determination as to whether control of reproduction of the content carried out in the reproduction control step is control corresponding to the instruction to control reproduction or not.

Namely, notification is provided based on the result of determination as to whether control of reproduction of the content carried out in the reproduction control step is control corresponding to the instruction to control reproduction of the content from the user or not. Therefore, an effect to eliminate confusion from the user when reproduction control expected by the user is not carried out can be achieved.

The control method according to the present invention includes: the program execution step of executing the reproduction control program for controlling reproduction of a content, the program execution step outputting a control instruction based on the instruction to control reproduction of the content from the user; the reproduction control step of controlling reproduction of the obtained content based on the control instruction; and the notification step of providing notification based on a result of determination as to whether control of reproduction of the content carried out in the reproduction control step is control corresponding to the instruction to control reproduction or not.

Namely, notification is provided based on the result of determination as to whether control of reproduction of the content carried out in the reproduction control step is control corresponding to the instruction to control reproduction of the content from the user or not. Therefore, an effect to eliminate confusion from the user when reproduction control expected by the user is not carried out can be achieved.

### BRIEF DESCRIPTION OF THE DRAWINGS

FIG. 1 is a functional block diagram of an internal configuration of a reproduction apparatus in the present embodiment.

FIG. 2 shows a file directory structure stored in a recording medium.

FIG. 3 is a functional block diagram of an internal configuration of a program execution unit.

FIG. 4 is a functional block diagram of an internal configuration of a reproduction control unit.

FIG. 5 is a functional block diagram of an internal configuration of a determination unit.

FIG. 6 is a flowchart of processing performed in the reproduction apparatus.

FIG. 7 is a flowchart of program execution processing.

FIG. 8 is a flowchart of state reception processing.

FIG. 9 is a flowchart of determination processing.

FIG. 10 is a diagram showing an operation rule table by way of example.

FIG. 11 is a diagram showing a notification image by way of example.

FIG. 12 is a diagram showing a notification image by way of example.

FIG. 13 is a block diagram showing an internal configuration of a reproduction apparatus by way of example.

FIG. 14 is a functional block diagram of an internal configuration of a conventional reproduction apparatus.

FIG. 15 is a diagram showing exemplary appearance of a remote controller.

### DESCRIPTION OF THE REFERENCE SIGNS

10, 10A recording medium; 12 control program; 100, 100A reproduction apparatus; 105, 105A control unit; 110 recording medium access unit; 120 RC signal reception unit; 130 program execution unit; 134 interpreter unit; 140 reproduction control unit; 150 AV decoding unit; 160 determination unit; 180 OSD generation unit; 190 combination unit; 200 remote controller; and 300 display apparatus.

### BEST MODES FOR CARRYING OUT THE INVENTION

An embodiment of the present invention will be described hereinafter with reference to the drawings. In the description below, the same elements have the same reference characters allotted, and their label and function are also identical. Therefore, detailed description thereof will not be repeated.

(System Configuration)

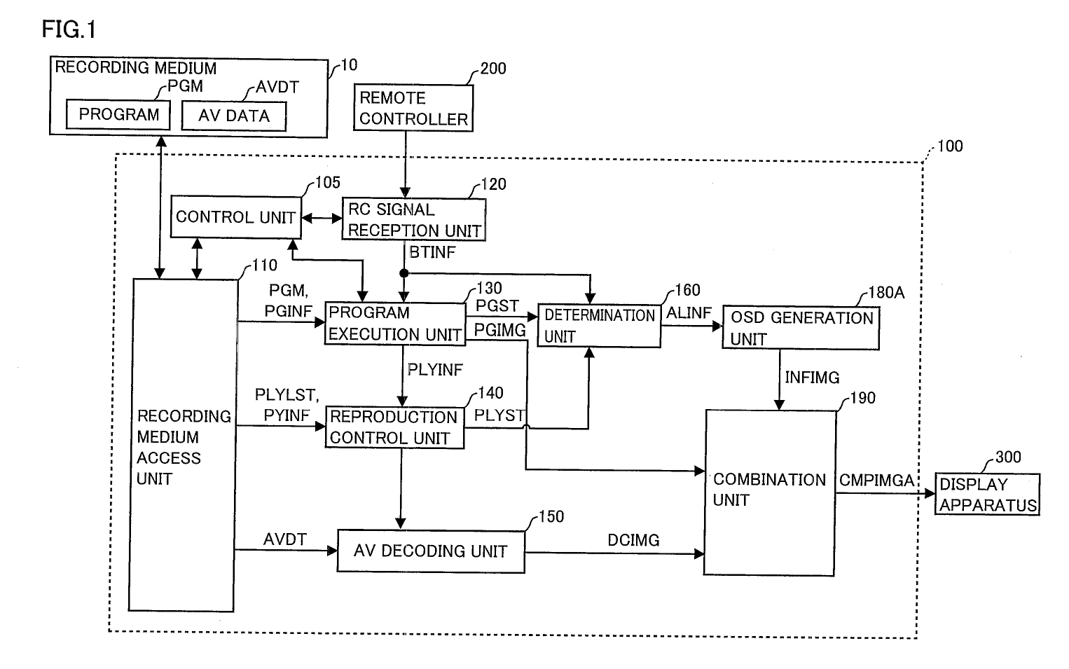

FIG. 1 is a functional block diagram of an internal configuration of a reproduction apparatus 100 in the present embodiment. FIG. 1 also shows recording medium 10, remote controller 200, and display apparatus 300 for the sake of illustration.

Recording medium 10 is a Blu-ray Disc (trademark). It is noted that recording medium 10 is not limited to a Blu-ray Disc (trademark). Recording medium 10 may be, for example, an HD DVD (trademark), a DVD-ROM (Digital Versatile Disk Read Only Memory), or the like. Recording medium 10 stores program PGM, AV (Audio Visual) data AVDT representing a content, playlist PLYLST, various types of data, and the like. Program PGM includes a reproduction control program for controlling reproduction of a content. Recording medium 10 is inserted in a not-shown insertion portion provided in reproduction apparatus 100.

Reproduction apparatus 100 is assumed as a reproduction apparatus complying with the BD specifications, however, reproduction apparatus 100 is not limited to the reproduction apparatus complying with the BD specifications. Reproduction apparatus 100 may be, for example, an apparatus capable of reproducing an HD DVD (trademark). Alternatively, reproduction apparatus 100 may be a PC (Personal Computer) incorporating a hardware decoder.

Display apparatus 300 is connected to reproduction apparatus 100. Namely, display apparatus 300 is a part of reproduction apparatus 100. Display apparatus 300 has a function to display a character, an image, or the like. Display apparatus 300 is an apparatus including any of an LCD panel, a CRT (Cathode Ray Tube), an FED panel, a PDP (Plasma Display Panel), and an organic EL display panel. It is noted that display apparatus 300 may be an apparatus including a panel adapted to a display scheme other than the above.

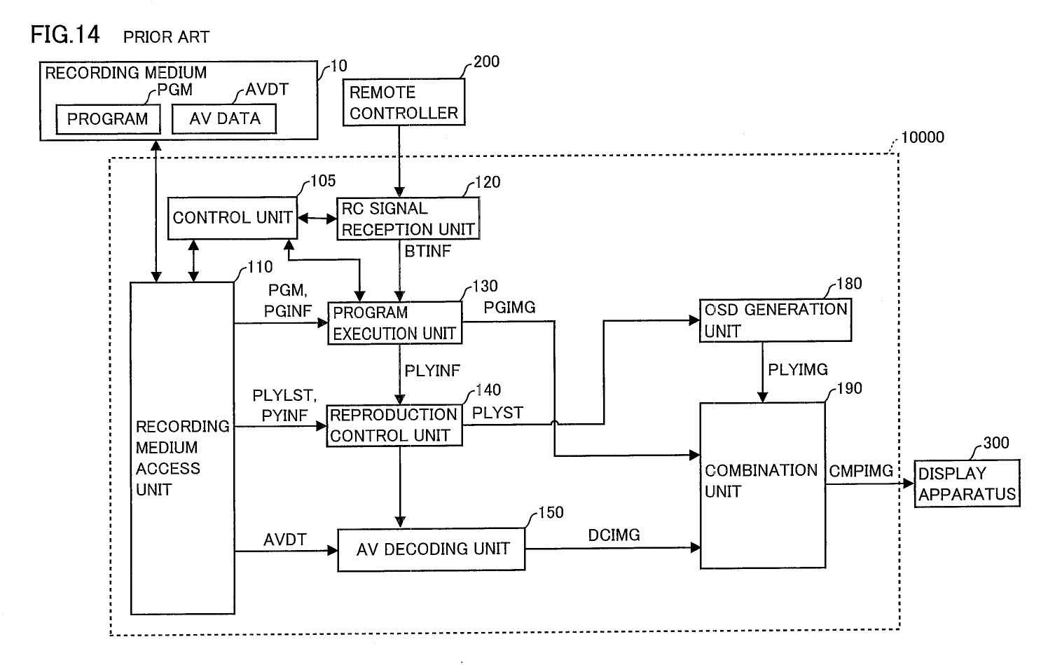

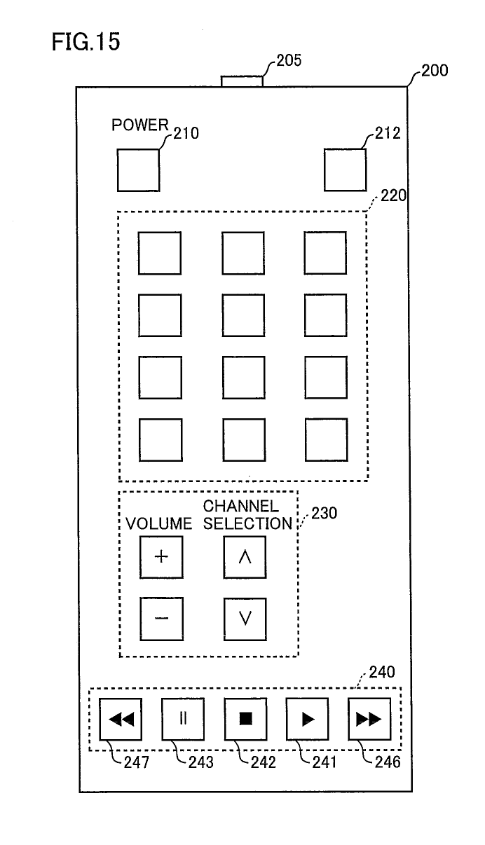

Referring to FIG. 1, reproduction apparatus 100 is different from reproduction apparatus 10000 in FIG. 14 in including an OSD generation unit 180A instead of OSD generation unit 180 and further including determination unit 160. As reproduction apparatus 100 is otherwise the same as reproduction apparatus 10000, detailed description will not be provided. Reproduction apparatus 100 is an apparatus capable of controlling reproduction of AV data AVDT representing a content by executing a reproduction control program included in program PGM recorded on recording medium 10.

Recording medium access unit 110 can read various types of data stored in recording medium 10 as a file through a file system.

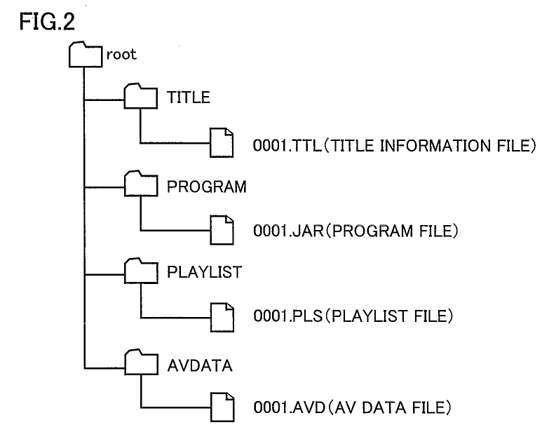

FIG. 2 shows a file directory structure stored in recording medium 10. Referring to FIG. 2, an AV data file is a file storing AV data AVDT. A playlist file is a file storing attribute information on playlist PLYLST and AV data AVDT. It is noted that playlist PLYLST is information on which part of AV data AVDT representing the content is to be reproduced and in which order it is to be reproduced.

A program file is a file storing program PGM configured with compiled Java (trademark) byte codes. It is noted that program PGM may be a program in other languages, without limited to the Java (trademark) language. As described previously, program PGM includes a reproduction control program for controlling reproduction of AV data AVDT representing a content.

A title information file is a file storing information on each of a plurality of content titles stored in recording medium 10. An example of stored information includes reference information of a program file used by each content title. It is noted that recording medium 10 stores a title information file indicating information on an automatically reproduced content (hereinafter also referred to as a title information file for automatic reproduction). A file name of a title information file for automatic reproduction is expressed, for example, as “0000.TTL”.

In addition, recording medium 10 stores file system management information for managing all data files stored in recording medium 10.

Referring again to FIG. 1, recording medium access unit 110 reads AV data AVDT, program PGM, playlist PLYLST, other auxiliary information INF, and the like from recording medium 10. As described previously, recording medium access unit 110 transmits program PGM and auxiliary information PGINF read from recording medium 10 to program execution unit 130. Auxiliary information PGINF is information relating to program PGM.

In addition, recording medium access unit 110 reads playlist PLYLST and auxiliary information PYINF from recording medium 10 based on a read instruction from control unit 105, and transmits read playlist PLYLST and auxiliary information PYINF to reproduction control unit 140. Auxiliary information PYINF is information relating to playlist PLYLST.

In addition, recording medium access unit 110 transmits AV data AVDT (content data) read from recording medium 10 to AV decoding unit 150.

RC signal reception unit 120 receives an RC signal transmitted from remote controller 200 described previously and converts the RC signal to button information BTINF corresponding to the received RC signal. Button information BTINF is information identifying a pressed button of remote controller 200. For example, if a received RC signal is the pause RC signal, button information BTINF indicates the button name “pause”. RC signal reception unit 120 transmits button information BTINF to control unit 105, program execution unit 130 and determination unit 160.

In addition to the processing described previously, control unit 105 further performs processing corresponding to received button information BTINF as necessary.

Program execution unit 130 controls reproduction control unit 140 and recording medium access unit 110 by executing program PGM transmitted from recording medium access unit 110.

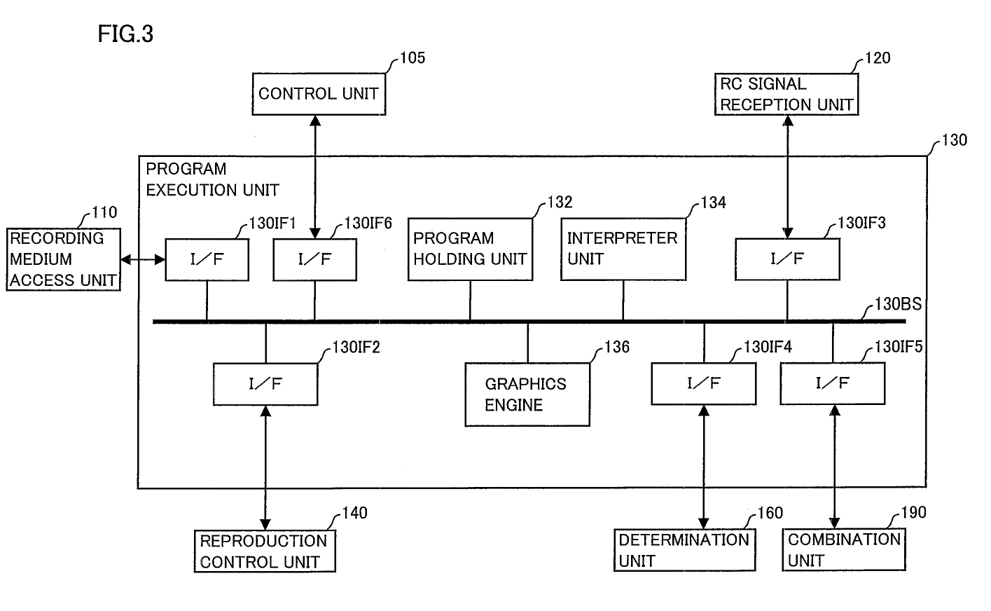

FIG. 3 is a functional block diagram of an internal configuration of program execution unit 130. FIG. 3 also shows recording medium access unit 110, control unit 105, RC signal reception unit 120, reproduction control unit 140, determination unit 160, and combination unit 190 for the sake of illustration.

Referring to FIG. 3, program execution unit 130 includes interfaces 130IF1, 130IF2, 130IF3, 130IF4, 130IF5, 130IF6, a program holding unit 132, an interpreter unit 134, a graphics engine 136, and a bus 130BS.

Each of interfaces 130IF1, 130IF2, 130IF3, 130IF4, 130IF5, 130IF6, program holding unit 132, interpreter unit 134, and graphics engine 136 is connected to bus 130BS.

Interface 130IF1 is connected to recording medium access unit 110. Interface 130IF2 is connected to reproduction control unit 140. Interface 130IF3 is connected to RC signal reception unit 120. Interface 130IF4 is connected to determination unit 160. Interface 130IF5 is connected to combination unit 190. Interface 130IF6 is connected to control unit 105.

Program holding unit 132 has a function to hold program PGM transmitted from recording medium access unit 110. Namely, program holding unit 132 is a memory capable of storing data.

Interpreter unit 134 performs a plurality of processes configuring program PGM held in program holding unit 132, successively from a first process.

When graphics drawing processing is included in the plurality of processes configuring program PGM, interpreter unit 134 causes graphics engine 136 to perform graphics drawing processing to generate image PGIMG. Image PGIMG is uncompressed bit map data. It is noted that image PGIMG may be compressed data (such as JPEG data), without limited to bit map data. Graphics engine 136 transmits generated image PGIMG to combination unit 190 through interface 130IF5.

Interpreter unit 134 performs button information analysis processing among the plurality of processes configuring program PGM. In the button information analysis processing, program execution unit 130 analyzes button information BTINF transmitted from RC signal reception unit 120.

Interpreter unit 134 performs content reproduction control processing among the plurality of processes configuring program PGM. Namely, interpreter unit 134 performs content reproduction control processing by executing the previously described reproduction control program included in program PGM.

In content reproduction control processing, reproduction control information PLYINF is transmitted to reproduction control unit 140 through interface 130IF2, based on analyzed button information BTINF.

Reproduction control information PLYINF is information for controlling reproduction of AV data AVDT representing the content. Reproduction control refers to control of contents, such as start of play, stop of play, pause of play, special play, and the like. Special play refers, for example, to fast play and slow play of contents.

In content reproduction control processing, when analyzed button information BTINF indicates a button name for carrying out control not permitted by the reproduction control program included in program PGM, interpreter unit 134 does not transmit reproduction control information PLYINF to reproduction control unit 140. For example, when the reproduction control program does not permit pause of a content being played and when the content is being played, interpreter unit 134 does not transmit reproduction control information PLYINF for control for pause of the content to reproduction control unit 140.

Program execution unit 130 is in any of an “uninitialized state”, a “stop state” and an “execution state”. When the power of reproduction apparatus 100 is turned on, program execution unit 130 is in the “uninitialized state”. When recording medium access unit 110 starts data access to recording medium 10, program execution unit 130 makes transition from the “uninitialized state” to the “stop state”. As will be described later, when control unit 105 indicates execution of a program, program execution unit 130 makes transition from the “stop state” to the “execution state”. When interpreter unit 134 ends execution of the program, program execution unit 130 makes transition from the “execution state” to the “stop state”.

It is noted that information indicating a state of program execution unit 130 is transmitted to determination unit 160 as an execution state PGST. Execution state PGST indicates any of the “uninitialized state”, the “stop state” and the “execution state”.

After program execution unit 130 transmits execution state PGST to determination unit 160 for the first time, each time the state thereof changes, program execution unit 130 transmits execution state PGST indicating a state after change of program execution unit 130 to determination unit 160.

It is noted that control unit 105 in FIG. 1 performs processing corresponding to received button information BTINF in addition to the processing described previously, when program execution unit 130 is in any of the “uninitialized state” and the “stop state”.

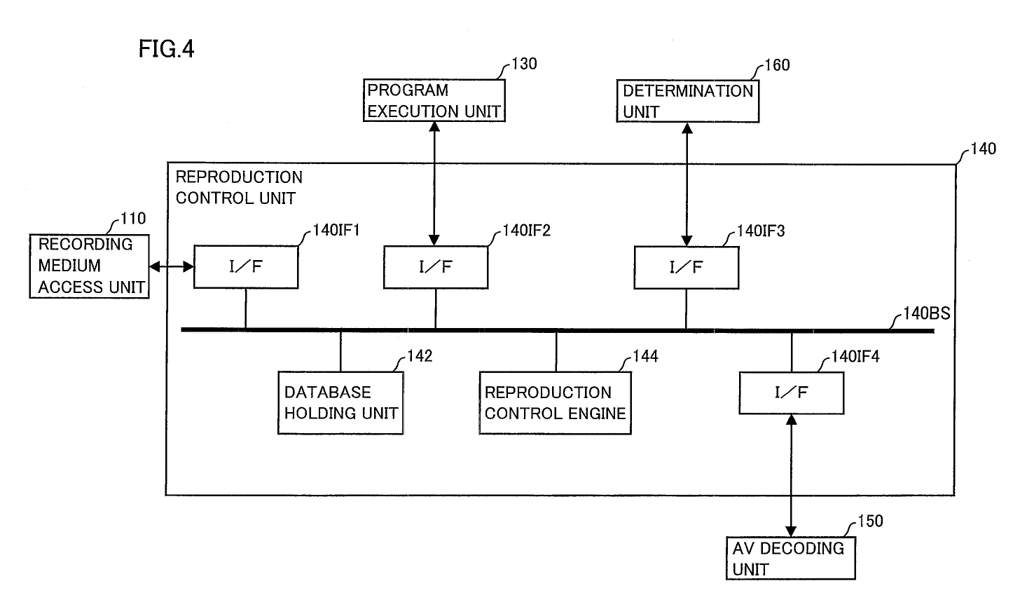

FIG. 4 is a functional block diagram of an internal configuration of reproduction control unit 140. FIG. 4 also shows recording medium access unit 110, program execution unit 130, determination unit 160, and AV decoding unit 150 for the sake of illustration.

Referring to FIG. 4, reproduction control unit 140 includes interfaces 140IF1, 140IF2, 140IF3, 140IF4, a database holding unit 142, a reproduction control engine 144, and a bus 140BS.

Each of interfaces 140IF1, 140IF2, 140IF3, 140IF4, database holding unit 142, and reproduction control engine 144 is connected to bus 140BS.

Interface 140IF1 is connected to recording medium access unit 110. Interface 140IF2 is connected to program execution unit 130. Interface 140IF3 is connected to determination unit 160. Interface 140IF4 is connected to AV decoding unit 150.

Reproduction control engine 144 operates based on reproduction control information PLYINF transmitted from program execution unit 130. Reproduction control engine 144 receives reproduction control information PLYINF through interface 140IF2.

Here, it is assumed that reproduction control information PLYINF indicates a playlist reproduction command and a playlist file name. In this case, reproduction control engine 144 gives a read instruction for reading a playlist having a playlist file name indicated by reproduction control information PLYINF from recording medium 10, to recording medium access unit 110 through interface 140IF1.

Recording medium access unit 110 reads the playlist having the playlist file name indicated by reproduction control information PLYINF from recording medium 10 based on the read instruction, and transmits the read playlist to reproduction control unit 140.

The playlist read by recording medium access unit 110 is held (stored) in database holding unit 142 through interface 140IF1.

Reproduction control engine 144 interprets the playlist held (stored) in database holding unit 142. It is assumed that the playlist indicates an AV data file name. In this case, reproduction control engine 144 gives to recording medium access unit 110, a read instruction for reading AV data AVDT having the AV data file name indicated by the playlist from recording medium 10.

Referring again to FIG. 1, recording medium access unit 110 reads AV data AVDT having the AV data file name indicated by the playlist from recording medium 10 based on the read instruction, and transmits read AV data AVDT to AV decoding unit 150. It is noted that AV data AVDT (content data) is data compressed in the MPEG (Moving Picture Experts Group) 2 format. Alternatively, AV data AVDT may be data compressed in other formats, without limited to data compressed in the MPEG2 format. Here, other formats include, for example, MPEG1, MPEG4, H.264, and the like.

When AV decoding unit 150 starts reception of AV data AVDT, reproduction control engine 144 gives a decoding instruction to AV decoding unit 150 through interface 140IF4. AV decoding unit 150 decodes AV data AVDT in response to the decoding instruction and successively converts the AV data to decoded image DCIMG as a frame. Decoded image DCIMG is an uncompressed image. In addition, AV decoding unit 150 decodes AV data AVDT in response to the decoding instruction and converts the AV data to uncompressed audio data (not shown).

Then, each time AV decoding unit 150 provides decoded image DCIMG as a frame, AV decoding unit 150 successively transmits decoded image DCIMG to combination unit 190.

Depending on a content play state, reproduction control unit 140 is in any of a “normal play state,” a “stop state”, a “pause state”, and a “special play state.” The “pause state” refers to such a state that an image is displayed on display apparatus 300 and a position where reproduction of a content was stopped is held. The “stop state” refers to such a state that an image is not displayed on display apparatus 300 and a position where reproduction of a content was stopped is not held.

Reproduction control unit 140 transmits play state information PLYST to determination unit 160. Play state information PLYST is information indicating a content play state in reproduction control unit 140. Namely, play state information PLYST is information indicating a state of reproduction of AV data AVDT representing a content. Play state information PLYST is information indicating any of the “normal play state,” the “stop state”, the “pause state”, and the “special play state” above.

After reproduction control unit 140 transmits play state information PLYST to determination unit 160 for the first time, each time the play state is changed, reproduction control unit 140 transmits to determination unit 160, play state information PLYST indicating the play state after change.

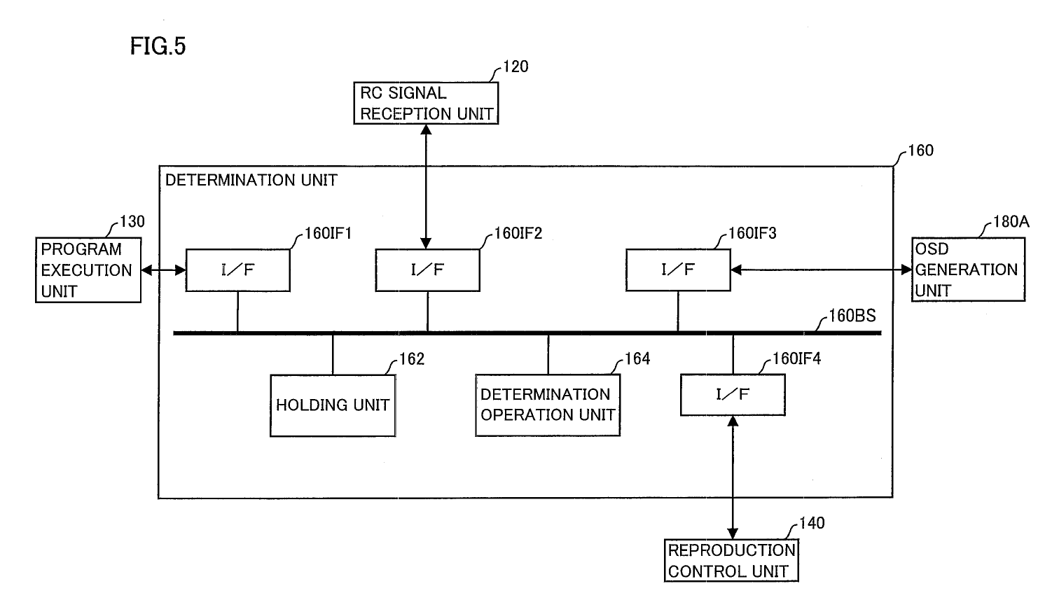

FIG. 5 is a functional block diagram of an internal configuration of determination unit 160, FIG. 5 also shows RC signal reception unit 120, program execution unit 130, reproduction control unit 140, and OSD generation unit 180A for the sake of illustration.

Referring to FIG. 5, determination unit 160 includes interfaces 160IF1, 160IF2, 160IF3, 160IF4, a holding unit 162, a determination operation unit 164, and a bus 160BS.

Each of interfaces 160IF1, 160IF2, 160IF3, 160IF4, holding unit 162, and determination operation unit 164 is connected to bus 160BS.

Interface 160IF1 is connected to program execution unit 130. Interface 160IF2 is connected to RC signal reception unit 120. Interface 160IF3 is connected to OSD generation unit 180A. Interface 160IF4 is connected to reproduction control unit 140.

Determination operation unit 164 receives execution state PGST transmitted from program execution unit 130 through interface 140IF1 and causes holding unit 162 to hold (store) received execution state PGST. If execution state PGST has already been held in holding unit 162, determination operation unit 164 erases execution state PGST held in holding unit 162 and causes holding unit 162 to hold (store) received latest execution state PGST.

In addition, determination operation unit 164 receives button information BTINF transmitted from RC signal reception unit 120 through interface 140IF2 and causes holding unit 162 to hold (store) received button information BTINF. If button information BTINF has already been held in holding unit 162, determination operation unit 164 erases button information BTINF held in holding unit 162 and causes holding unit 162 to hold (store) received latest button information BTINF.

Moreover, determination operation unit 164 receives play state information PLYST transmitted from reproduction control unit 140 through interface 140IF4 and causes holding unit 162 to hold (store) received play state information PLYST. If play state information PLYST has already been held in holding unit 162, determination operation unit 164 erases play state information PLYST held in holding unit 162 and causes holding unit 162 to hold (store) received latest play state information PLYST.

Further, determination operation unit 164 determines whether or not the current content play state indicates a state of control corresponding to the button manipulated by the user as indicated by button information BTINF, in accordance with button information BTINF transmitted from RC signal reception unit 120, execution state PGST transmitted from program execution unit 130, and play state information PLYST transmitted from reproduction control unit 140. Then, determination operation unit 164 transmits notification information ALINF which will be described later to OSD generation unit 180A as necessary.

Referring again to FIG. 1, OSD generation unit 180A generates a notification image INFIMG based on received notification information ALINF, which will be described in detail later. It is noted that notification image INFIMG is uncompressed bit map data. Notification image INFIMG may be compressed data (such as JPEG data), without limited to bit map data. OSD generation unit 180A transmits generated notification image INFIMG to combination unit 190.

Combination unit 190 generates a composite image CMPIMGA obtained by combining decoded image DCIMG transmitted from AV decoding unit 150, image PGIMG transmitted from program execution unit 130, and notification image INFIMG transmitted from OSD generation unit 180A in a manner superimposed on one another. Then, combination unit 190 transmits composite image CMPIMGA to display apparatus 300 connected to reproduction apparatus 100.

Display apparatus 300 displays received composite image CMPIMGA.

(Processing in Reproduction Apparatus)

Processing performed in reproduction apparatus 100 after the power of reproduction apparatus 100 is turned on will now be described.

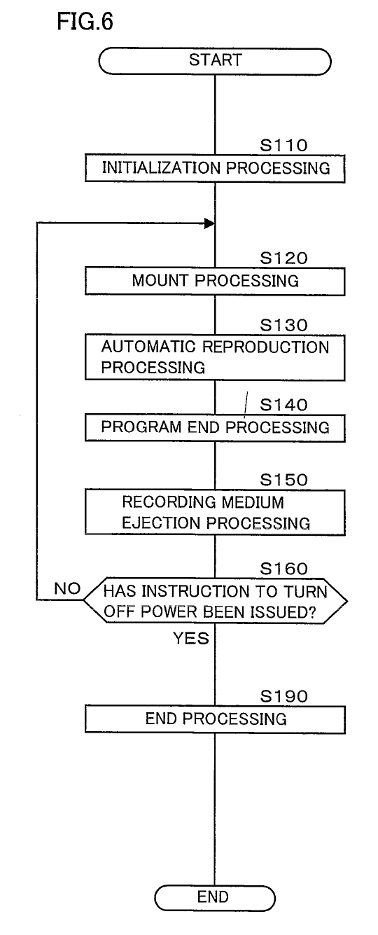

FIG. 6 is a flowchart of processing performed in reproduction apparatus 100. Referring to FIG. 6, in step S110, various types of initialization processing are performed. For example, the initialization processing includes such processing that each unit in reproduction apparatus 100 becomes operable. Then, the process proceeds to step S120.

In step S120, mount processing is performed. In the mount processing, when recording medium 10 is inserted in the not-shown insertion portion provided in reproduction apparatus 100, recording medium access unit 110 reads file system management information described previously from recording medium 10 so that each piece of data stored in recording medium 10 can be accessed as a file. As described previously, the file system management information is information for managing all data files stored in recording medium 10. In addition, when recording medium 10 is inserted in the insertion portion, control unit 105 provides an instruction to make transition to a stop state to program execution unit 130. Program execution unit 130 makes transition from the “uninitialized state” to the “stop state”, in response to the instruction to make transition to the stop state. Then, the process proceeds to step S130.

In step S130, automatic reproduction processing is performed. In the automatic reproduction processing, recording medium access unit 110 reads a title information file (title information file for automatic reproduction) having a file name of “0000.TTL” that is stored in recording medium 10. Then, recording medium access unit 110 informs program execution unit 130 of a program file name indicated in the read title information file for automatic reproduction.

In addition, when recording medium access unit 110 reads the title information file for automatic reproduction stored in recording medium 10, control unit 105 gives to program execution unit 130, an instruction to execute a program having the program file name indicated in the title information file for automatic reproduction that is read by recording medium access unit 110. Thus, program execution unit 130 makes transition from the “stop state” to the “execution state”, in response to the instruction to execute the program. Then, program execution unit 130 in the “execution state” executes a program corresponding to the instruction to execute the program (such as program PGM) and performs processing for content reproduction (button information analysis processing, content reproduction control processing, or the like).

If an instruction to automatically start playing a content is given in program PGM being executed by program execution unit 130, program execution unit 130 transmits reproduction control information PLYINF for reading a content to be played (AV data AVDT) from recording medium 10 to reproduction control unit 140. Receiving reproduction control information PLYINF for reading a content, reproduction control unit 140 transmits an instruction to read a content to be played (AV data AVDT) to recording medium access unit 110.

Receiving the instruction to read the content, recording medium access unit 110 reads the content to be played (AV data AVDT) from recording medium 10. Then, recording medium access unit 110 transmits the read content (AV data AVDT) to AV decoding unit 150. Then, in the content reproduction control processing, program execution unit 130 transmits reproduction control information PLYINF indicating start of play of the content to be played (AV data AVDT) to reproduction control unit 140.

Receiving reproduction control information PLYINF indicating start of play, reproduction control unit 140 starts play of AV data AVDT to be played, through AV decoding unit 150. Here, reproduction control unit 140 transmits play state information PLYST indicating the “normal play state” to determination unit 160.

When execution of the program by program execution unit 130 ends or when ejection of recording medium 10 is indicated through user's manipulation of remote controller 200, control unit 105 performs program end processing (step S140) and thereafter performs recording medium ejection processing (step S150).

In the program end processing, control unit 105 gives a stop instruction to program execution unit 130. Thus, program execution unit 130 makes transition from the “execution state” to the “stop state” in response to the stop instruction.

The recording medium ejection processing is processing for ejecting recording medium 10 inserted in the not-shown insertion portion provided in reproduction apparatus 100 to the outside of reproduction apparatus 100.

When a power-off instruction for turning off the power of reproduction apparatus 100 is given through user's manipulation of remote controller 200 (YES in step S160), end processing (step S190) is performed. The end processing is processing for turning off the power of reproduction apparatus 100.

(Program Execution Processing)

Processing by program execution unit 130 when control unit 105 gives an instruction to execute a program to program execution unit 130 in the processing described previously (hereinafter also referred to as program execution processing) will now be described. Here, it is assumed that program execution unit 130 is informed of a program file name indicated by the title information file for automatic reproduction from recording medium access unit 110 in the processing described previously.

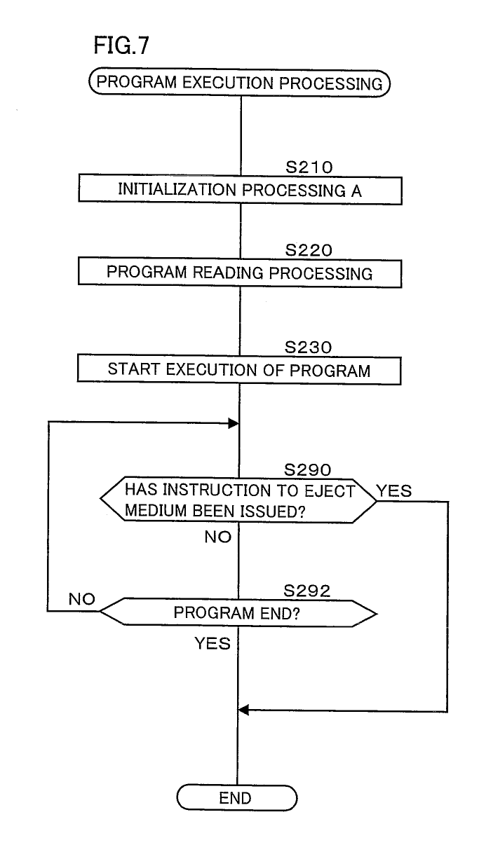

FIG. 7 is a flowchart of the program execution processing. Referring to FIG. 7, in step S210, initialization processing A is performed. In initialization processing A, each unit included in program execution unit 130 (such as program holding unit 132, interpreter unit 134, and graphics engine 136) is initialized. In addition, in response to the execution instruction from control unit 105, program execution unit 130 makes transition from the “stop state” to the “execution state”. Then, the process proceeds to step S220.

In step S220, program read processing is performed. In the program read processing, program execution unit 130 gives to recording medium access unit 110, a read instruction for reading from recording medium 10, program PGM having a program file name of which program execution unit 130 was informed from recording medium access unit 110.

In response to the read instruction, recording medium access unit 110 reads program PGM from recording medium 10 and transmits read program PGM to program execution unit 130.

Receiving program PGM, program execution unit 130 causes program holding unit 132 to hold received program PGM. Then, the process proceeds to step S230.

In step S230, execution of the program is started. Specifically, interpreter unit 134 performs a plurality of processes configuring program PGM held in program holding unit 132, successively from the first process. Namely, interpreter unit 134 interprets a plurality of byte codes configuring program PGM, successively from a first byte code, and performs corresponding processing.

Thus, interpreter unit 134 causes graphics engine 136 to perform graphics drawing processing described previously. In addition, interpreter unit 134 performs button information analysis processing. As described previously, button information analysis processing is the processing for program execution unit 130 to analyze button information BTINF transmitted from RC signal reception unit 120.

In addition, as described previously, interpreter unit 134 performs content reproduction control processing by executing the reproduction control program included in program PGM. In the content reproduction control processing, reproduction control information PLYINF is transmitted to reproduction control unit 140 based on analyzed button information BTINF. Namely, as described previously, interpreter unit 134 controls reproduction control unit 140 for controlling reproduction of AV data AVDT representing the content.

As described previously, in the content reproduction control processing, if analyzed button information BTINF indicates a button name for carrying out control not permitted by the reproduction control program included in program PGM, interpreter unit 134 does not transmit reproduction control information PLYINF to reproduction control unit 140. For example, when the reproduction control program does not permit pause of the content being played and when the content is being played, interpreter unit 134 does not transmit reproduction control information PLYINF for control for pause of the content to reproduction control unit 140. Then, the process proceeds to step S290.

In step S290, program execution unit 130 determines whether an instruction to eject a medium has been issued or not. The instruction to eject a medium is an instruction to eject recording medium 10 inserted in the not-shown insertion portion of reproduction apparatus 100 to the outside. The instruction to eject a medium is an instruction transmitted to program execution unit 130 when RC signal reception unit 120 receives a medium ejection RC signal from remote controller 200. Namely, when the user presses medium ejection button 212 of remote controller 200, the medium ejection RC signal is transmitted from remote controller 200 to RC signal reception unit 120 and the instruction to eject a medium is transmitted from RC signal reception unit 120 to program execution unit 130. Here, program execution unit 130 determines that the instruction to eject a medium has been issued.

When determination as YES is made in step S290, recording medium 10 inserted in the not-shown insertion portion of reproduction apparatus 100 is ejected to the outside, program execution unit 130 makes transition from the “execution state” to the “stop state”, and this program execution processing ends. On the other hand, when determination as NO is made in step S290, the process proceeds to step S292.

In step S292, whether execution of the program has ended or not is determined. Specifically, when interpreter unit 134 interprets a byte code indicating end of the processing of the program among the plurality of byte codes configuring program PGM and when that byte code is executed, it is determined that execution of the program has ended. When determination as YES is made in step S292, program execution unit 130 makes transition from the “execution state” to the “stop state” and this program execution processing ends. On the other hand, when determination as NO is made in step S292, the processing in step S290 is performed again.

(Processing by Determination Unit)

Processing performed when determination unit 160 receives a state of program execution unit 130 and reproduction control unit 140 (hereinafter also referred to as state reception processing) will now be described. The state reception processing is processing performed independently of other processing.

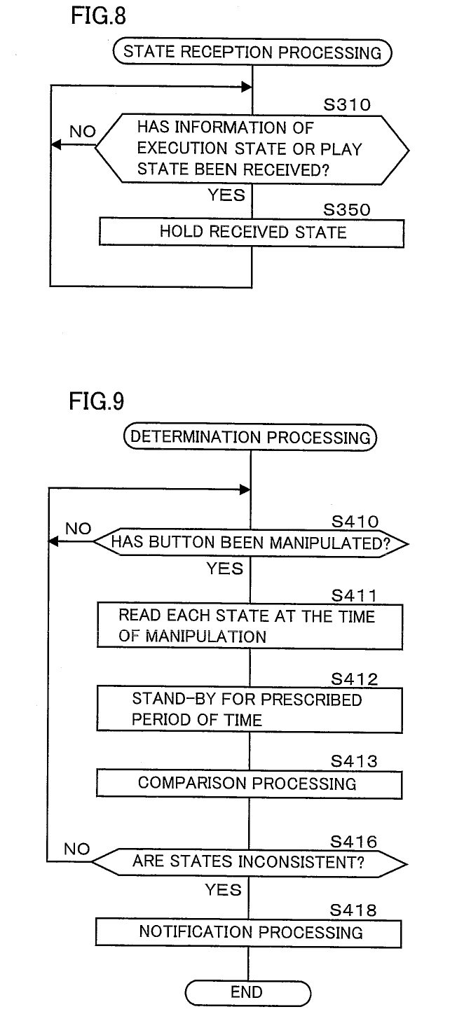

FIG. 8 is a flowchart of the state reception processing. Referring to FIG. 8, in step S310, whether determination operation unit 164 in determination unit 160 has received execution state PGST transmitted from program execution unit 130 or play state information PLYST transmitted from reproduction control unit 140 or not. When determination as YES is made in step S310, the process proceeds to step S350. On the other hand, when determination as NO is made in step S310, the processing in step S310 is performed again.

In step S350, the received state is held. Specifically, when execution state PGST is received, determination operation unit 164 causes holding unit 162 to hold (store) received execution state PGST. If execution state PGST has already been held in holding unit 162, determination operation unit 164 erases execution state PGST held in holding unit 162 and causes holding unit 162 to hold (store) received latest execution state PGST.

Alternatively, when play state information PLYST is received, determination operation unit 164 causes holding unit 162 to hold (store) received play state information PLYST. If play state information PLYST has already been held in holding unit 162, determination operation unit 164 erases play state information PLYST held in holding unit 162 and causes holding unit 162 to hold (store) received latest play state information PLYST. Then, the processing in step S310 is performed again.

(Processing at the Time when Button is Manipulated)

Processing by determination unit 160 (hereinafter also referred to as determination processing) will now be described. The determination processing is processing performed independently of other processing. Here, it is assumed that program execution unit 130 is in the “execution state”. In addition, it is assumed that reproduction control unit 140 is in the “normal play state”. Namely, it is assumed that a content is being played in reproduction apparatus 100. In addition, it is assumed that program PGM corresponding to the content being played is executed by interpreter unit 134 in program execution unit 130.

FIG. 9 is a flowchart of the determination processing. Referring to FIG. 9, in step S410, whether a button has been manipulated or not is determined. Specifically, whether determination operation unit 164 has received button information BTINF from RC signal reception unit 120 or not is determined. When determination as YES is made in step S410, the process proceeds to step S411. On the other hand, when determination as NO is made in step S410, the processing in step S410 is performed again. Here, assuming that button information BTINF has been received, the process proceeds to step S411. Here, it is assumed that received button information BTINF is information indicating the button name “pause”. Namely, it is assumed that pause button 243 in remote controller 200 has been pressed.

In step S411, each state at the time when a button is manipulated is read. Specifically, determination operation unit 164 reads execution state PGST and play state information PLYST stored in holding unit 162. Execution state PGST and play state information PLYST read in step S411 are hereinafter also referred to as manipulation-timing execution state PGST and manipulation-timing play state information PLYST, respectively. Here, it is assumed that manipulation-timing execution state PGST indicates the “execution state”. In addition, it is assumed that manipulation-timing play state information PLYST indicates the “normal play state.” Namely, the content play state in reproduction control unit 140 is the “normal play state.” Then, the process proceeds to step S412.

In step S412, determination operation unit 164 stands by for a prescribed period of time (for example, 2 seconds). Then, the process proceeds to step S413. While determination unit 160 performs processing for stand-by for a prescribed period of time in step S412, processing below is performed.

Initially, program execution unit 130 performs processing in accordance with button information BTINF received from RC signal reception unit 120. Here, it is assumed that button information BTINF is information indicating the button name “pause”. It is assumed that interpreter unit 134 in program execution unit 130 performs content reproduction control processing by executing the reproduction control program included in program PGM. Here, it is assumed that the button name “pause” indicated by button information BTINF is a button name for carrying out control not permitted by the reproduction control program.

Here, interpreter unit 134 does not transmit reproduction control information PLYINF for carrying out control for pause of the content to reproduction control unit 140.

Here, the content play state in reproduction control unit 140 is not varied. Therefore, play state information PLYST held in holding unit 162 is not varied. In addition, here, the state of program execution unit 130 is not varied. Therefore, execution state PGST held in holding unit 162 is not varied either.

In step S413, comparison processing is performed. In the comparison processing, whether content reproduction control carried out by reproduction control unit 140 is control corresponding to button information BTINF received from RC signal reception unit 120 or not is determined. Specifically, initially, determination operation unit 164 reads execution state PGST and play state information PLYST currently stored in holding unit 162. Execution state PGST and play state information PLYST read in the comparison processing in step S413 are hereinafter also referred to as post-manipulation execution state PGST and post-manipulation play state information PLYST, respectively.

Then, determination operation unit 164 compares the following operation rule table T100, manipulation-timing execution state PGST and manipulation-timing play state information PLYST described previously that are read in the processing in step S411, and post-manipulation execution state PGST and post-manipulation play state information PLYST with each other, based on received button information BTINF.

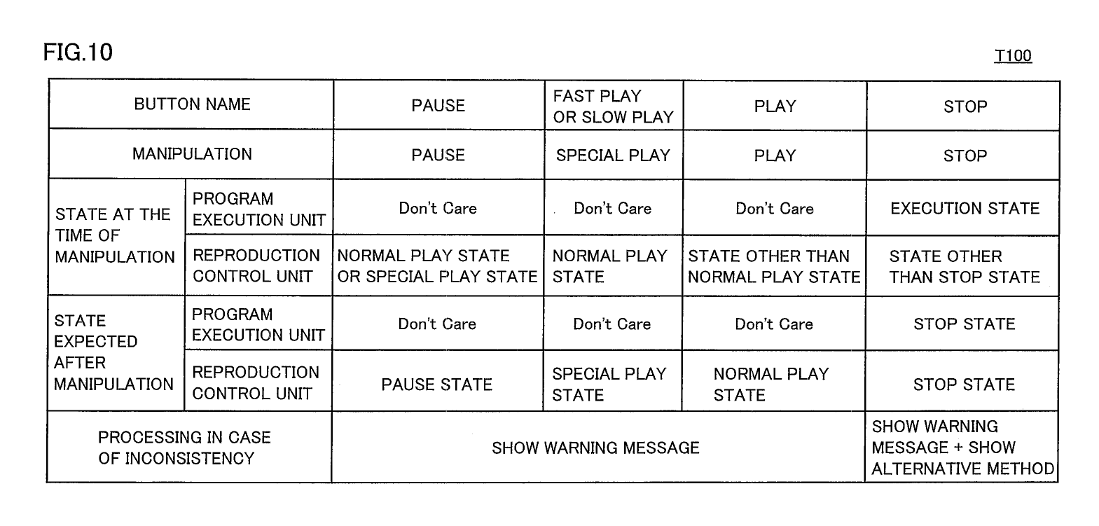

FIG. 10 is a diagram showing operation rule table T100 by way of example. Referring to FIG. 10, the “button name” is a button name indicated by button information BTINF received by determination operation unit 164. “Manipulation” is denotation of a content reproduction manipulation corresponding to received button information BTINF.

The “state at the time of manipulation” is a state of program execution unit 130 and reproduction control unit 140 at the time when a button is manipulated. The states of program execution unit 130 and reproduction control unit 140 are states indicated by manipulation-timing execution state PGST and manipulation-timing play state information PLYST, respectively. “Don't Care” means that a result of comparison is not taken into consideration in the comparison processing in step S413.

The “state expected after manipulation” is a state of program execution unit 130 and reproduction control unit 140 after a prescribed period of time (such as 2 seconds) has elapsed since button manipulation. The “processing in case of inconsistency” is processing performed in the comparison processing when determination as inconsistent is made in the comparison processing, as will be described later.

Referring again to FIG. 9, specific processing in the comparison processing in step S413 will be described. Here, it is assumed that received button information BTINF is information indicating the button name “pause”.

Here, in the comparison processing, determination operation unit 164 compares a state specified by a column indicated by the “button name” “pause” and a row of “program execution unit” corresponding to the “state at the time of manipulation” in operation rule table T100 (hereinafter also referred to as state A) with manipulation-timing execution state PGST (execution state) described previously. In operation rule table T100, state A is “Don't Care”, and determination operation unit 164 determines as states not being inconsistent.

In addition, in the comparison processing, determination operation unit 164 compares a state specified by a column indicated by the “button name” “pause” and a row of “program execution unit” corresponding to the “state expected after manipulation” in operation rule table T100 (hereinafter also referred to as state B) with post-manipulation execution state PGST (execution state) described previously. In operation rule table T100, state B is “Don't Care”, and determination operation unit 164 determines as states not being inconsistent.

Moreover, in the comparison processing, determination operation unit 164 compares a state specified by a column indicated by the “button name” “pause” and a row of “reproduction control unit” corresponding to the “state at the time of manipulation” in operation rule table T100 (hereinafter also referred to as state C) with manipulation-timing play state information PLYST described previously. It is assumed that manipulation-timing play state information PLYST indicates the “normal play state” as described previously. State C indicates a “normal play state or special play state.” Here, determination operation unit 164 determines as states being consistent.

Further, in the comparison processing, determination operation unit 164 compares a state specified by a column indicated by the “button name” “pause” and a row of “reproduction control unit” corresponding to the “state expected after manipulation” in operation rule table T100 (hereinafter also referred to as state D) with post-manipulation play state information PLYST described previously. Post-manipulation play state information PLYST remains the same as manipulation-timing play state information PLYST as described previously, and indicates the “normal play state.” State D indicates the “pause state”. Here, determination operation unit 164 determines as states being inconsistent.

In the comparison processing above, if determination operation unit 164 makes even a single determination as the states being inconsistent, a result of determination by determination operation unit 164 indicates the states being inconsistent. Here, content reproduction control carried out by reproduction control unit 140 is not control corresponding to button information BTINF received from RC signal reception unit 120. Alternatively, if determination operation unit 164 does not make any determination as the states being inconsistent, a result of determination by determination operation unit 164 indicates the states being consistent. Here, content reproduction control carried out by reproduction control unit 140 is consistent with control corresponding to button information BTINF received from RC signal reception unit 120. When every comparison is completed, the process proceeds to step S416. Here, it is assumed that determination operation unit 164 has made determination as the states being inconsistent.

In step S416, determination operation unit 164 determines whether the result of determination in the comparison processing indicates the states being inconsistent or not. When determination as YES is made in step S416, the process proceeds to step S418. On the other hand, when determination as NO is made in step S416, the processing in step S410 is again performed. Here, assuming that the result of determination in the comparison processing indicates the states being inconsistent, the process proceeds to step S418.

In step S418, notification processing is performed. In the notification processing, processing specified by received button information BTINF in operation rule table T100 in FIG. 10 is performed. Here, it is assumed that received button information BTINF is information indicating the button name “pause”.

Here, in the notification processing, determination operation unit 164 performs processing specified by a column indicated by the “button name” “pause” and the “processing in case of inconsistency” in operation rule table T100 (hereinafter also referred to as processing K). Processing K is processing for displaying a warning message.

Specifically, determination operation unit 164 transmits notification information ALINF to OSD generation unit 180A. Here, it is assumed that notification information ALINF is information including a warning message. The warning message is a message indicating that the user's manipulation is not permitted. The warning message is, for example, a message that “pause of content being played is not allowed.” Thus, the processing in this step S418 ends.

Then, OSD generation unit 180A generates the following notification image MG100 based on received notification information ALINF.

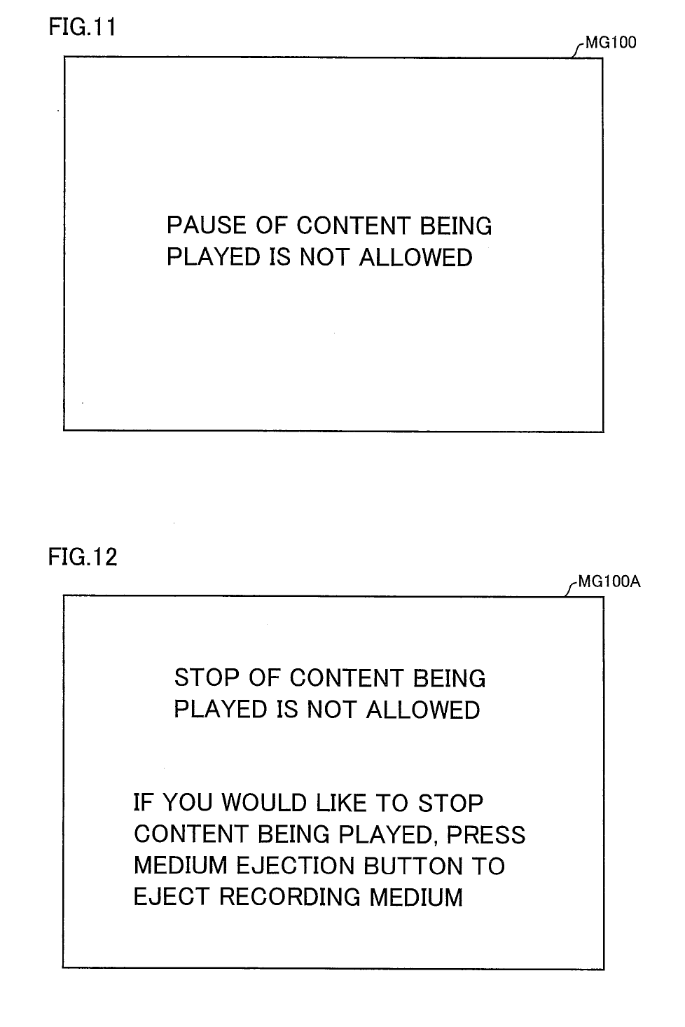

FIG. 11 is a diagram showing notification image MG100 by way of example.

Then, OSD generation unit 180A transmits generated notification image MG100 to combination unit 190.

Combination unit 190 generates composite image CMPIMGA obtained by combining decoded image DCIMG transmitted from AV decoding unit 150, image PGIMG transmitted from program execution unit 130, and notification image MG100 transmitted from OSD generation unit 180A in a manner superimposed on one another. Here, composite image CMPIMGA is an image showing notification image MG100 giving the warning message.

Then, combination unit 190 transmits composite image CMPIMGA to display apparatus 300.

Display apparatus 300 displays received composite image CMPIMGA. Composite image CMPIMGA displayed on display apparatus 300 is an image showing notification image MG100 giving the warning message.

Through the processing above, the user can be notified of the fact that the user's manipulation is not permitted. Therefore, when content reproduction control corresponding to user's manipulation is not carried out in such a state that the reproduction control program for controlling reproduction of a content to be reproduced does not permit a specific manipulation in reproduction apparatus 100, user's confusion can be prevented. Namely, an effect to eliminate confusion from the user when reproduction control expected by the user is not carried out can be achieved.

Processing when the user performs a manipulation different from the manipulation described previously in the determination processing in FIG. 9 will now be described. Here, it is assumed that program execution unit 130 is in the “execution state”. In addition, it is assumed that reproduction control unit 140 is in the “normal play state.” Namely, it is assumed that a content is being played in reproduction apparatus 100. In addition, it is assumed that program PGM corresponding to the content being played is being executed by interpreter unit 134 in program execution unit 130.

Referring again to FIG. 9, as the processing the same as described previously is performed in step S410, detailed description will not be repeated. Here, assuming that button information BTINF has been received, the process proceeds to step S411. Here, it is assumed that received button information BTINF is information indicating a button name “stop”. Namely, it is assumed that stop button 242 in remote controller 200 has been pressed.

As the processing the same as described previously is performed in step S411, detailed description will not be repeated. Assuming that manipulation-timing execution state PGST indicating the “execution state” and manipulation-timing play state information PLYST indicating the “normal play state” were read in this processing, the process proceeds to step S412.

As the processing the same as described previously is performed in step S412, detailed description will not be repeated. Here, while determination unit 160 performs processing for stand-by for a prescribed period of time, processing below is performed.

Initially, program execution unit 130 performs processing in accordance with button information BTINF received from RC signal reception unit 120. Here, it is assumed that button information BTINF is information indicating the button name “stop”. It is noted that interpreter unit 134 in program execution unit 130 is performing content reproduction control processing by executing the reproduction control program included in program PGM. Here, it is assumed that the button name “stop” indicated by button information BTINF is a button name for carrying out control not permitted by the reproduction control program.

Here, interpreter unit 134 does not transmit reproduction control information PLYINF for content stop control to reproduction control unit 140.

Here, the content play state in reproduction control unit 140 is not varied. Therefore, play state information PLYST held in holding unit 162 is not varied. In addition, here, the state of program execution unit 130 is not varied. Therefore, execution state PGST held in holding unit 162 is not varied either.

In step S413, the comparison processing described previously is performed. In the comparison processing, as described previously, determination operation unit 164 reads post-manipulation execution state PGST and post-manipulation play state information PLYST. Then, determination operation unit 164 compares operation rule table T100 in FIG. 10, manipulation-timing execution state PGST and manipulation-timing play state information PLYST read in the processing in step S411, and post-manipulation execution state PGST and post-manipulation play state information PLYST with each other, based on received button information BTINF.

Here, it is assumed that received button information BTINF is information indicating the button name “stop”.

Here, in the comparison processing, determination operation unit 164 compares a state specified by a column indicated by the “button name” “stop” and a row of “program execution unit” corresponding to the “state at the time of manipulation” in operation rule table T100 (hereinafter also referred to as state A1) with manipulation-timing execution state PGST (execution state) described previously. In operation rule table T100, as state A1 is the “execution state”, determination operation unit 164 determines as the states being consistent.

In addition, in the comparison processing, determination operation unit 164 compares a state specified by a column indicated by the “button name” “stop” and a row of “program execution unit” corresponding to the “state expected after manipulation” in operation rule table T100 (hereinafter also referred to as state B1) with post-manipulation execution state PGST (execution state) described previously. In operation rule table T100, as state B1 is the “stop state”, determination operation unit 164 determines as the states being inconsistent.

Moreover, in the comparison processing, determination operation unit 164 compares a state specified by a column indicated by the “button name” “stop” and a row of “reproduction control unit” corresponding to the “state at the time of manipulation” in operation rule table T100 (hereinafter also referred to as state C1) with manipulation-timing play state information PLYST described previously. It is assumed that manipulation-timing play state information PLYST indicates the “normal play state” as described previously. State C1 indicates a “state other than stop state.” Here, determination operation unit 164 determines as the states being consistent.

Further, in the comparison processing, determination operation unit 164 compares a state specified by a column indicated by the “button name” “stop” and a row of “reproduction control unit” corresponding to the “state expected after manipulation” in operation rule table T100 (hereinafter also referred to as state D1) with post-manipulation play state information PLYST described previously. Post-manipulation play state information PLYST remains the same as manipulation-timing play state information PLYST as described previously, and indicates the “normal play state.” State D1 indicates the “stop state”. Here, determination operation unit 164 determines as the states being inconsistent.

In the comparison processing above, if determination operation unit 164 makes even a single determination as the states being inconsistent, a result of determination by determination operation unit 164 indicates the states being inconsistent. Here, content reproduction control carried out by reproduction control unit 140 is not control corresponding to button information BTINF received from RC signal reception unit 120. When every comparison is completed, the process proceeds to step S416. Here, it is assumed that determination operation unit 164 has made determination as the states being inconsistent.

As the processing the same as described previously is performed in step S416, detailed description will not be repeated. Assuming here that the result of determination in the comparison processing indicates the states being inconsistent, the process proceeds to step S418.

In step S418, the notification processing described previously is performed. In the notification processing, processing specified by received button information BTINF in operation rule table T100 is performed. Here, it is assumed that received button information BTINF is information indicating the button name “stop”.

Here, in the notification processing, determination operation unit 164 performs processing specified by a column indicated by the “button name” “stop” and the “processing in case of inconsistency” in operation rule table T100 (hereinafter also referred to as processing K1). Processing K1 is processing for presenting an alternative method in addition to display of a warning message.

Specifically, determination operation unit 164 transmits notification information ALINF to OSD generation unit 180A. Here, it is assumed that notification information ALINF is information including a warning message and a message presenting an alternative method. The warning message is a message indicating that the user's manipulation is not permitted. The warning message is, for example, a message that “stop of content being played is not allowed.” The message presenting an alternative method is, for example, a message that “if you would like to stop content being played, press medium ejection button to eject recording medium.” Thus, the processing in this step S418 ends.

Then, OSD generation unit 180A generates the following notification image MG100A based on received notification information ALINF.

FIG. 12 is a diagram showing notification image MG100A by way of example.

Then, OSD generation unit 180A transmits generated notification image MG100A to combination unit 190.

Combination unit 190 generates composite image CMPIMGA obtained by combining decoded image DCIMG transmitted from AV decoding unit 150, image PGIMG transmitted from program execution unit 130, and notification image MG100A transmitted from OSD generation unit 180A in a manner superimposed on one another. Here, composite image CMPIMGA is an image showing notification image MG100A indicating the warning message and the message presenting an alternative method.

Then, combination unit 190 transmits composite image CMPIMGA to display apparatus 300.

Display apparatus 300 displays received composite image CMPIMGA. Composite image CMPIMGA displayed on display apparatus 300 is an image showing notification image MG 00 indicating the warning message and the message presenting an alternative method.

Through the processing above, the user can be notified of the fact that the user's manipulation is not permitted. Therefore, when content reproduction control corresponding to user's manipulation is not carried out in such a state that the reproduction control program for controlling reproduction of a content to be reproduced does not permit a specific manipulation in reproduction apparatus 100, user's confusion can be prevented. Namely, an effect to eliminate confusion from the user when reproduction control expected by the user is not carried out can be achieved.

In addition, a manipulation as desired by the user can be performed by notifying the user of an alternative method, while intention of a content creator is reflected.

If a specific user's manipulation is restricted by a method other than the reproduction control program included in program PGM that corresponds to the content being played, the user may be given a warning message, that such user's manipulation is not permitted, or the like on display apparatus 300, with such user's manipulation being excluded from state monitoring by determination unit 160.

In the present embodiment, processing in a case where the reproduction control program does not permit a specific manipulation has been described, however, the present invention is not limited as such. The present invention is still applicable to a case, for example, where the reproduction control program assigns processing other than the processing for stopping the content being played to stop button 242 in remote controller 200, or a case, for example, where processing different from the processing that should essentially be operated is performed when stop button 242 in remote controller 200 is manipulated due to bugs of the reproduction control program.

In the present embodiment, processing for displaying notification image MG100 or notification image MG100A in a manner superimposed on a content reproduction picture based on decoded image DCIMG has been described. The present invention, however, is not limited to the processing above, and any means may be adopted so long as a message can be conveyed to the user. For example, a location where a notification image is displayed may be a display portion (not shown) of a front panel provided outside reproduction apparatus 100 or a display portion (not shown) provided in remote controller 200. A form of display may be in an icon form, instead of a character. In addition, an aural method (for example, a method using voice and sound) may naturally be adopted as a notification method, without limited to a visual method.

The present embodiment is based on the premise that a content is read from recording medium 10, however, applications of the present invention are not limited as such. For example, the present invention is also applicable to a content obtained through broadcasting or through a network.

All or some of control unit 105, program execution unit 130, reproduction control unit 140, and determination unit 160 shown within reproduction apparatus 100 may be configured with a hardware logic.

In addition, all of control unit 105, program execution unit 130, reproduction control unit 140, and determination unit 160 may be configured with a CPU representing one piece of hardware, and processing performed in each of control unit 105, program execution unit 130, reproduction control unit 140, and determination unit 160 described previously may be performed by a control program executed by the CPU. A reproduction apparatus in such a case is configured as in a reproduction apparatus 100A below.

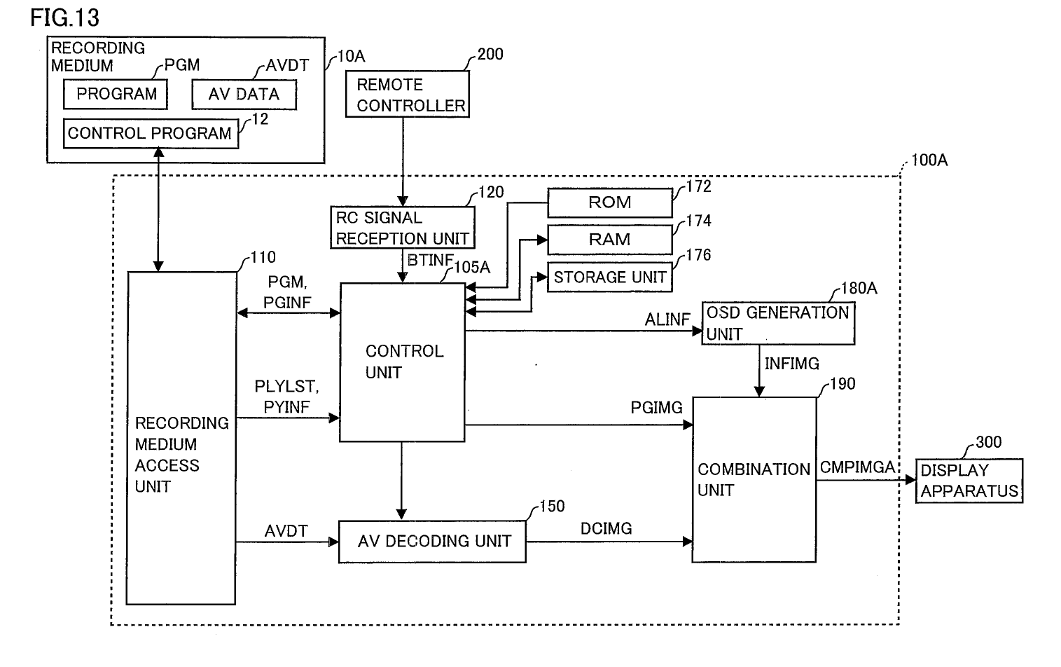

FIG. 13 is a block diagram showing an internal configuration of reproduction apparatus 100A by way of example. FIG. 13 also shows a recording medium 10A for the sake of illustration. Recording medium 10A is different from recording medium 10 in FIG. 1 in further storing a control program 12 which will be described later. As recording medium 10A is otherwise the same as recording medium 10, detailed description will not be repeated. Namely, control program 12 is recorded in a medium or the like and distributed as a program product. In addition, recording medium 10A is also distributed as a program product.

Recording medium 10A may be any of a Blu-ray Disc (trademark), an HD DVD (trademark), a DVD-ROM (Digital Versatile Disk Read Only Memory), a DVD-R (Digital Versatile Disk Recordable), a DVD-RAM (Digital Versatile Disk Random Access Memory), a DVD+RW (Digital Versatile Disk Re-Writable), a DVD-RW, a CD-ROM (Compact Disk Read Only Memory), an MO (Magneto Optical Disk), an MD (Mini Disc) (trademark), a floppy (trademark) disc, a CF (Compact Flash) card (trademark), an SM (Smart Media (trademark)), an MMC (Multi Media Card (trademark)), an SD (Secure Digital (trademark)) memory card (trademark), a memory stick (trademark), an xD picture card, a USB memory, a magnetic tape, a cassette tape, an IC card (including a memory card), an optical card, a mask ROM, an EPROM, an EEPROM, a flash ROM, and a non-volatile memory other than the above.

Referring to FIG. 13, reproduction apparatus 100A is different from reproduction apparatus 100 in FIG. 1 in not including program execution unit 130, reproduction control unit 140 and determination unit 160, including a control unit 105A instead of control unit 105, and further including a ROM (Read Only Memory) 172, a RAM (Random Access Memory) 174 and a storage unit 176. As reproduction apparatus 100A is otherwise the same as reproduction apparatus 100, detailed description will not be repeated.

Control unit 105A may be implemented by any of a CPU (Central Processing Unit), a microprocessor (Microprocessor), an FPGA (Field Programmable Gate Array), an ASIC (Application Specific Integrated Circuit), a DSP (Digital Signal Processor), and other circuits having an operation function.

Control unit 105A accesses each of ROM 172, RAM 174 and storage unit 176 for data.

ROM 172 stores control program 12, Control unit 105A performs the processing described previously performed by each of control unit 105, program execution unit 130, reproduction control unit 140, and determination unit 160 described previously (for example, step S130 in FIG. 6, the program execution processing in FIG. 7, the determination processing in FIG. 9, and the like) by executing control program 12 stored in ROM 172.

Storage unit 176 has a function to store data in a non-volatile manner. Storage unit 176 is a hard disk capable of storing data of a large capacity. It is noted that storage unit 176 is not limited to the hard disk and it may be any medium (such as a flash memory) capable of holding data in a non-volatile manner without supply of power.

Reproduction apparatus 100A may not include ROM 172. Here, control program 12 stored in recording medium 10A is read by recording medium access unit 110 through installation processing by control unit 105A and control unit 105A causes storage unit 176 to store control program 12. The program for installation processing is stored in advance in storage unit 176 and the installation processing is performed by control unit 105A based on the program for installation processing.

Then, control unit 105A performs the processing described previously performed by each of control unit 105, program execution unit 130, reproduction control unit 140, and determination unit 160 described previously (for example, step S130 in FIG. 6, the program execution processing in FIG. 7, the determination processing in FIG. 9, and the like) by executing control program 12 stored in storage unit 176.

Control program 12 may not be installed in storage unit 176. Here, control unit 105A performs the processing described previously by reading control program 12 stored in recording medium 10A through recording medium access unit 110 and executing control program 12.

Namely, the present invention can be achieved also by supply of recording medium 10A recording in a computer-readable manner a program code (an execute form program, an intermediate code program, and a source program) of control program 12 for reproduction apparatus 100A, which represents software attaining the functions described above, to reproduction apparatus 100A above and by an operation of the computer (control unit 105A) to read and execute control program 12 recorded in recording medium 10A.

According to the present invention, reproduction apparatus 100A may be configured such that it can be connected to a communication network and control program 105A may download control program 12 through the communication network and execute control program 12. The communication network is not particularly limited, and for example, the Internet, an intranet, an extranet, LAN, ISDN, VAN, a CATV communication network, a virtual private network, a telephone network, a mobile communication network, a satellite communication network, and the like are available.

In addition, a transmission medium included in a communication network is not particularly limited, and for example, wire communication such as IEEE1394 (Institute of Electrical and Electronic Engineers 1394), a USB (Universal Serial Bus), a power line carrier, a cable TV circuit, a telephone line, and an ADSL line, or wireless communication such as infrared, for example, IrDA, Bluetooth (trademark), 802.11 radio, HDR, a cellular phone network, a satellite circuit, and a digital terrestrial network is also available.

The present invention can be implemented also by control unit 105A receiving control program 12 included in a carrier wave and executing control program 12.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

As the reproduction apparatus according to the present invention can efficiently execute a program to be executed, in synchronization with reproduction of AV data (content) or the like, it can suitably be used for a video player on which graphic output generated by a computer program is superimposed for display during content reproduction.

1. A reproduction apparatus capable of executing a reproduction control program for controlling reproduction of a content, comprising:
an obtaining unit for obtaining said content and said reproduction control program;
a program execution unit for executing said reproduction control program;
an acceptance unit for accepting an instruction to control reproduction of said content from a user;
a reproduction control unit for controlling reproduction of said content obtained by said obtaining unit, based on a control instruction from said program execution unit based on said instruction to control reproduction accepted by said acceptance unit;
a determination unit for determining whether control of reproduction of said content carried out by said reproduction control unit is control corresponding to said instruction to control reproduction accepted by said acceptance unit; and
a notification unit for providing notification based on a result of determination by said determination unit.

2. The reproduction apparatus according to claim 1, wherein
said notification unit provides notification when said determination unit determines that said control of reproduction of said content carried out by said reproduction control unit is not said control corresponding to accepted said instruction to control reproduction.

3. The reproduction apparatus according to claim 1, wherein
said control instruction issued by said program execution unit to said reproduction control unit based on said instruction to control reproduction is an instruction for control permitted in said reproduction control program.

4. A control program executed by a computer capable of executing a reproduction control program for controlling reproduction of a content, said control program comprising:
an obtaining step of obtaining said content and said reproduction control program;
a program execution step of executing said reproduction control program;
an acceptance step of accepting an instruction to control reproduction of said content from a user, said program execution step including a step of outputting a control instruction based on said instruction to control reproduction accepted in said acceptance step;
a reproduction control step of controlling reproduction of said content obtained in said obtaining step based on said control instruction;
a determination step of determining whether control of reproduction of said content carried out in said reproduction control step is control corresponding to said instruction to control reproduction accepted in said acceptance step; and
a notification step of providing notification based on a result of determination in said determination step.

5. The control program according to claim 4, wherein
in said notification step, notification is provided when it is determined in said determination step that said control of reproduction of said content carried out in said reproduction control step is not said control corresponding to accepted said instruction to control reproduction.

6. A computer-readable recording medium recording the control program according to claim 4 or 5.

7. A control method performed in a reproduction apparatus capable of executing a reproduction control program for controlling reproduction of a content, comprising:
an obtaining step of obtaining said content and said reproduction control program;
a program execution step of executing said reproduction control program;
an acceptance step of accepting an instruction to control reproduction of said content from a user, said program execution step including a step of outputting a control instruction based on said instruction to control reproduction accepted in said acceptance step;
a reproduction control step of controlling reproduction of said content obtained in said obtaining step based on said control instruction;
a determination step of determining whether control of reproduction of said content carried out in said reproduction control step is control corresponding to said instruction to control reproduction accepted in said acceptance step; and
a notification step of providing notification based on a result of determination in said determination step.

8. The control method according to claim 7, wherein
in said notification step, notification is provided when it is determined in said determination step that said control of reproduction of said content carried out in said reproduction control step is not said control corresponding to accepted said instruction to control reproduction.
